(19) United States
(12) Patent Application Publication
(10) Pub. No.: US 2015/0180269 A1
(43) Pub. Date: Jun. 25, 2015

(54) POWER SUPPLY DEVICE

(71) Applicant: Kabushiki Kaisha Toshiba, Tokyo (JP)

(72) Inventor: Akio Kanou, Ome (JP)

(21) Appl. No.: 14/552,170

(22) Filed: Nov. 24, 2014

Related U.S. Application Data
(60) Provisional application No. 61/919,124, filed on Dec. 20, 2013.

(51) Int. Cl. H02J 7/02; G06F 3/0354; H02J 17/00

(52) U.S. Cl. CPC H02J 7/025; H02J 17/00; G06F 3/0354

(57) ABSTRACT

One embodiment provides a power supply device. The power supply device includes: a body housing; a cover which covers a body housing; a receiving module; and a transmitting module. The receiving module receives power from an external contactless power supply module. The transmitting module is disposed in the cover, and supplies power to an external apparatus.

### CROSS-REFERENCE TO RELATED APPLICATION(S)

This application claims priority from U.S. Provisional Patent Application No. 61/919,124 filed on Dec. 20, 2013, the entire contents of which are incorporated herein by reference.

### TECHNICAL FIELD

An embodiment of the present invention relates to a power supply device.

### BACKGROUND

There are many examples in which, when an information apparatus such as a notebook PC is to be used, an external apparatus that requires a battery, such as a wireless mouse is connected. In such an external apparatus, when the battery is exhausted, however, a replacement of the battery with a new one is required in the case of a primary battery, or a charging work is required in the case of a secondary battery. In the case where the battery is dead immediately before a meeting or a presentation and there is no spare battery, for example, the user's performance is lowered.

For example, conventional examples have the following problems:

(1) in the case where a wireless mouse is charged by a USB-connected cradle,

in order to charge the mouse, a cradle and a mouse pad are additionally necessary, and it negatively causes troubles of carrying them and of sacrificing a space on a desk therefor; and

(2) in the case where a USB-connected mouse pad is formed as a contactless power supply transmitting module, and power is supplied to a mouse including a receiving module,

terminals connected to a power supply exist in the mouse, and therefore the usage environment of the mouse should be cared so that the terminals are protected from dust, water, and the like.

Namely, there is a request for a method in which, in order to perform easily and stably a power supply, a transmitting module is preferably or straight newly disposed in an information apparatus having a contactless power supply reception function, thereby performing a contactless power supply on a secondary battery in an external apparatus such as a wireless mouse. However, means for realizing the request has not been known.

### BRIEF DESCRIPTION OF DRAWINGS

FIG. 1 is a perspective view showing an example of the appearance of an electronic apparatus of an embodiment.

FIG. 2 is a block diagram showing an example of the system configuration of the electronic apparatus of the embodiment.

FIG. 3 is a functional block diagram illustrating main portions of the system of the embodiment.

FIG. 4 is a view showing an example (a wireless mouse and a notebook PC) of the embodiment.

FIG. 5 is a functional block diagram showing an application example (power supply from a receiving step-down regulator input to a transmitting module) used in the embodiment.

FIG. 6 is a functional block diagram showing a modification (ON/OFF of a transmitting module and a regulator of a preceding stage by sensor information) of the embodiment.

### DESCRIPTION OF EMBODIMENTS

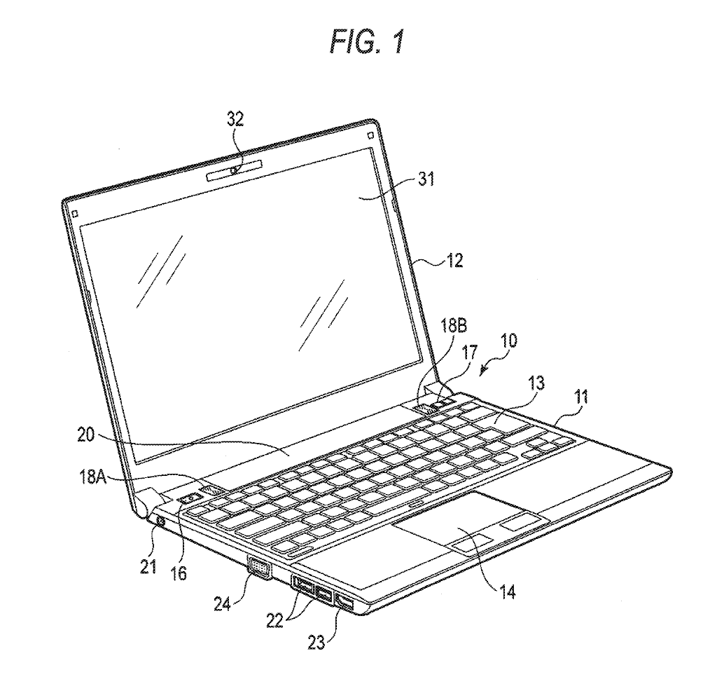

Hereinafter, an embodiment will be described with reference to FIGS. 1 to 6.

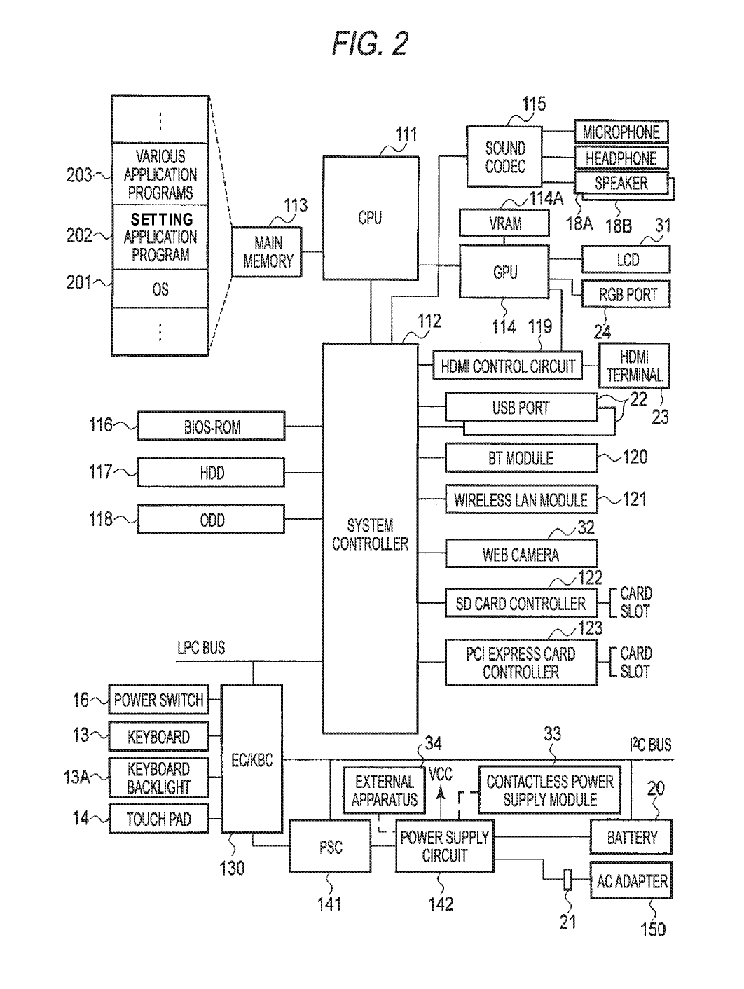

First, the whole configuration of an electronic apparatus of an embodiment of an information apparatus will be described with reference to FIGS. 1 and 2. The electronic apparatus can be realized as, for example, a portable personal computer of the notebook type, a tablet terminal, or one of other various information processing apparatuses.

FIG. 1 is a perspective view of a notebook type computer 10 in which a display unit is in an opened state, as viewed from the front side. The computer 10 is configured so as to receive power from a battery 20. The computer 10 includes the computer body 11 and the display unit 12. A display device such as a liquid crystal display device (LCD) 31 is incorporated into the display unit 12. A camera (Web camera) 32 is placed in an upper end portion of the display unit 12.

The display unit 12 is swingably attached to the computer body 11 so as to move between an opened position at which the upper surface of the computer body 11 is exposed, and a closed position at which the upper surface of the computer body 11 is covered with the display unit 12. The computer body 11 has a housing shaped in a thin box. On the upper surface, a keyboard 13, a touch pad 14, a power switch 16 for powering ON/OFF the computer 10, several function buttons 17, and speakers 18A, 18B are placed.

In addition, the computer body 11 is provided with a power supply connector 21. The power supply connector 21 is disposed on a side surface, for example, a left side surface of the computer body 11. An external power supply device is detachably connected to the power supply connector 21. An AC adapter may be used as the external power supply device. An AC adapter is a power supply device which converts a commercial power supply (AC power) into DC power.

The battery 20 is detachably mounted on, for example, a rear end portion of the computer body 11. The battery 20 may be a battery built in the computer 10.

The computer 10 is driven by power from the external power supply device or that from the battery 20. When the external power supply device is connected to the power supply connector 21 of the computer 10, the computer 10 is driven by the power from the external power supply device. The power from the external power supply device is also used for charging the battery 20. The computer 10 is driven by the power from the battery 20 during a period when the external power supply device is not connected to the power supply connector 21 of the computer 10.

The computer body 11 is provided with some USB ports 22, an HDMI (High-Definition Multimedia Interface) output terminal 23, and an RGB port 24.

FIG. 2 shows a system (power supply object) configuration of the computer 10. The computer 10 includes a CPU 111, a system controller 112, a main memory 113, a graphics processing unit (GPU) 114, a sound codec 115, a BIOS-ROM 116, a hard disk drive (HDD) 117, an optical disk drive (ODD) 118, a BT (Bluetooth (registered trademark)) module 120, a wireless LAN module 121, an SD card controller 122, a PCI EXPRESS card controller 123, an embedded controller/keyboard controller IC (EC/KBC) 130, a keyboard backlight 13A, a power supply controller (PSC) 141, a power supply circuit 142, etc.

The CPU 111 is a processor which controls operations of the components of the computer 10. The CPU 111 executes various types of software which are loaded from the HDD 117 onto the main memory 113. The software includes an operating system (OS) 201, a setting application program 202, the description of which is omitted, and various application programs 203. The various application programs 203 include the above-described desktop and full-screen applications.

The CPU 111 also executes a basic input output system (BIOS) stored in the BIOS-ROM 116 which is a non-volatile memory. The BIOS is a system program for hardware control.

The GPU 114 is a display controller which controls the LCD 31 employed as a display monitor of the computer 10. The GPU 114 generates a display signal (LVDS signal) which is to be supplied to the LCD 31, from display data stored in a video memory (VRAM) 114A. The GPU 114 can also generate an analog RGB signal and an HDMI video signal from the display data. The analog RGB signal is supplied to an external display device via the RGB port 24. The HDMI output terminal 23 can transmit an HDMI video signal (non-compressed digital video signal) and a digital audio signal to the external display device through a single cable. An HDMI control circuit 119 is an interface which sends the HDMI video signal and the digital audio signal to the external display device via the HDMI output terminal 23.

The system controller 112 is a bridge device which makes connection between the CPU 111 and each of the components. The system controller 112 incorporates a serial ATA controller for controlling the hard disk drive (HDD) 117 and the optical disk drive (ODD) 118. The system controller 112 executes communication with each of the devices on an LPC (Low PIN Count) bus.

The EC/KBC 130 is connected to the LPC bus. The EC/KBC 130, the power supply controller (PSC) 141, and the battery 20 are interconnected via a serial bus such as an 12C bus.

The EC/KBC 130 is a power management controller which executes power management of the computer 10, and implemented as a one-chip microcomputer integrating, for example, a keyboard controller for controlling the keyboard (KB) 13, the touch pad 14, and the like. The EC/KBC 130 has a function to power ON/OFF the computer 10 in response to the user's manipulation on the power switch 16. The control of powering ON/OFF the computer 10 is executed by a cooperative operation of the EC/KBC 130 and the power supply controller (PSC) 141. Upon receipt of an ON signal sent from the EC/KBC 130, the power supply controller (PSC) 141 controls the power supply circuit 142 to power ON the computer 10. Upon receipt of an OFF signal sent from the EC/KBC 130, the power supply controller (PSC) 141 controls the power supply circuit 142 to power OFF the computer 10. The EC/KBC 130, the power supply controller (PSC) 141, and the power supply circuit 142 operate with the electric power from the battery 20 or an AC adapter 150 even during a period when the computer 10 is powered OFF.

The EC/KBC 130 can turn ON/OFF the keyboard backlight 13A which is placed on the back surface of the keyboard 13. The EC/KBC 130 is further connected to a panel opening/closing switch 131 which detects opening/closing of the display unit 12. When the opening of the display unit 12 is detected by the panel opening/closing switch 131, the EC/KBC 130 can power ON the computer 10.

The power supply circuit 142 generates power (operational power supply) which is to be supplied to each of the components, by using the power supplied from the battery 20 or that supplied from the AC adaptor 150 which is connected to the computer body 11 as the external power supply. The power supply circuit 142 further receives power from a contactless power supply module 33 by, for example, the electromagnetic induction method, and obtains a DC voltage by using a circuit (receiving module). For example, the circuit functions as a high-frequency power supply upon receipt of a constant AC current from the contactless power supply module 33, and includes: a pickup coil wound around a pickup core in proximity to a power supply line which is connected to the high-frequency power supply, and through which, when a preset current is supplied, a high-frequency current flows; a resonance capacitor which is connected in parallel to the pickup coil; a rectifier which uses a diode bridge that is connected in parallel to the resonance capacitor; and a constant voltage circuit which controls a current output from the rectifier, to a predetermined voltage.

The power supply circuit 142 supplies power to an external apparatus 34 by, for example, the electromagnetic induction method via a circuit (transmitting module), and the external apparatus 34 obtains the DC voltage. The transmitting module is a circuit functioning as a so-called contactless power supply device, and includes, for example, the power supply line connected to the high-frequency power supply which outputs the constant AC current. For example, a pickup coil mounted on the external apparatus 34 is placed in proximity to the power supply line, thereby performing a power supply.

### First Example

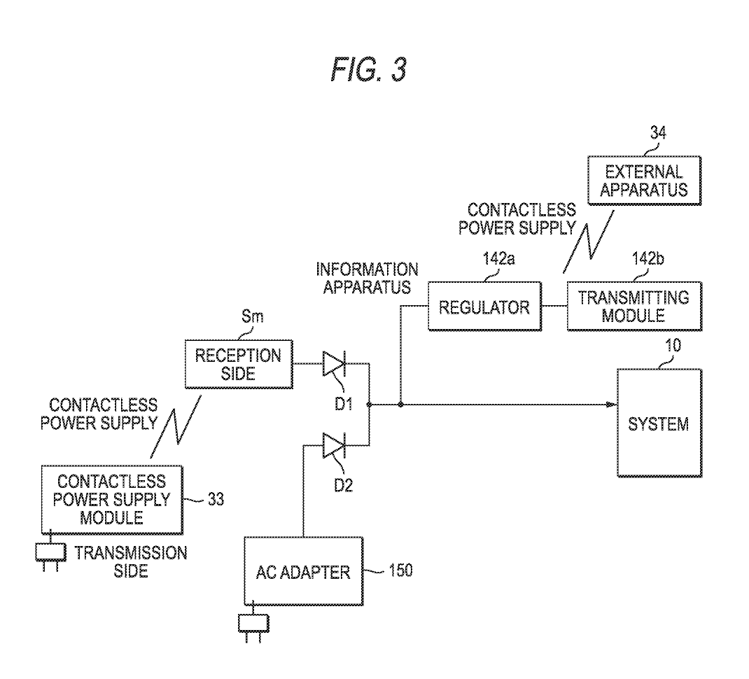

FIG. 3 is a functional block diagram illustrating main portions of the embodiment of the power supply device, and centered on the power supply circuit 142. A reception side Sm (receiving module), diodes D1 and D2, a regulator 142a, and a transmitting module 142b are included in the power supply circuit 142. The reception side Sm obtains the above-described DC voltage. The diodes D1 and D2 select the higher one of the above-described DC voltage and the output voltage of the AC adapter 150 supplied via the power supply connector 21 for the power supply.

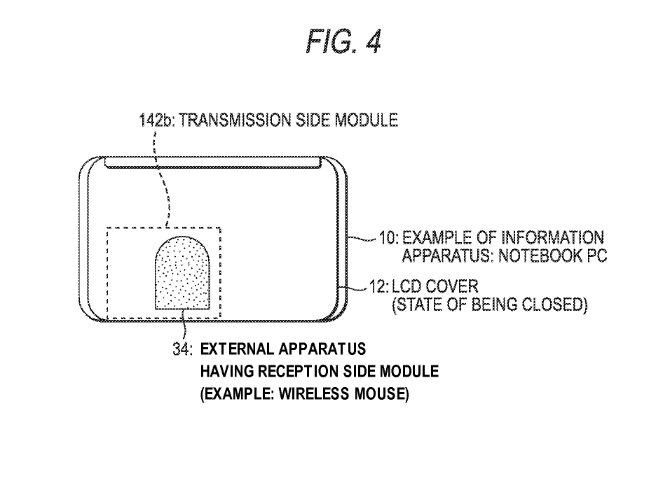

FIG. 3 is a functional block diagram illustrating main portions of the system of the embodiment, and FIG. 4 is a view sowing an example (a wireless mouse and a notebook PC) of the embodiment. In the information apparatus (hereinafter, referred to as the notebook PC) having a contactless power supply reception function, a transmission function is added to the interior of the notebook PC in order to supply power to the external apparatus 34 (hereinafter, a wireless mouse is exemplified) having a contactless power supply reception function. As shown in the system block diagram of FIG. 3, a power supply bus due to contactless power supply, and that due to the AC adapter 150 are connected to each other through a diode OR, and then supplied to the system.

The transmitting module 142b is disposed, power is supplied (as required, via a regulator) from the power supply bus which is connected to the system, and contactless power supply is performed on the external apparatus 34. In the case where a transmission side module (transmitting module 142b) is built in the LCD cover (display unit 12) (LID) of the notebook PC as shown in the example view FIG. 4, the secondary battery in the mouse can be configured to be charged when the LCD of the notebook PC is closed (during returning to the office, the holiday, and the like) and the wireless mouse is placed on an upper portion of the notebook PC. Although various apparatuses may be used as the external apparatus 34, the power supply will be performed in accordance with the rating of the wireless mouse.

### Second Example

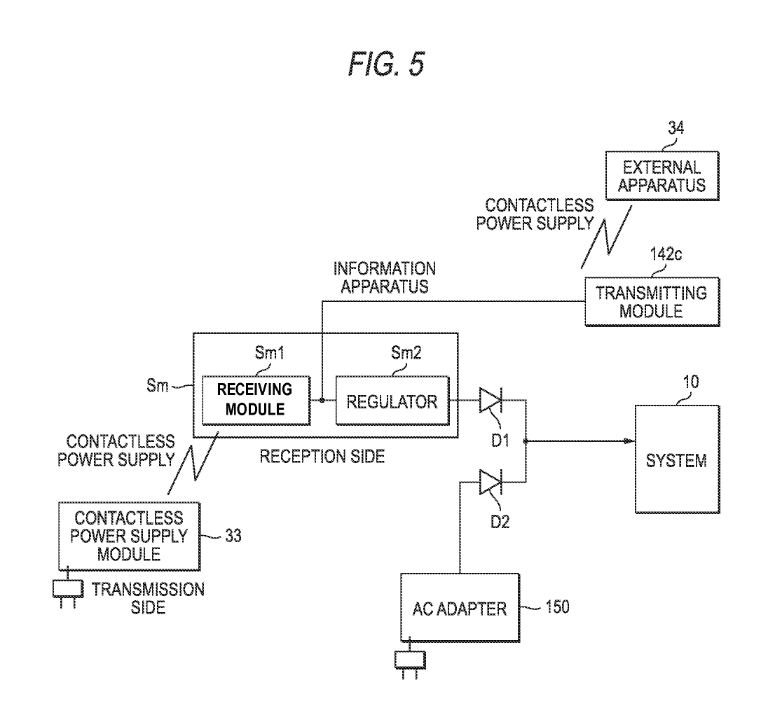

FIG. 5 is a functional block diagram showing an application example (power supply from a receiving step-down regulator input to the transmitting module) used in the embodiment. As shown in the application block diagram of FIG. 5, a regulator Sm2 exists in the reception side Sm as the contactless power supply reception module, to step down a voltage (about 25 V to 35 V) received from the transmission side (contactless power supply module 33) to a voltage (19 V) which is to be supplied to the system. When power is supplied from the input of the regulator Sm2 in the reception side Sm to a transmitting module 142c for a contactless power supply to the external apparatus 34, it is possible to reduce the power conversion loss (about 5% to 10%) of the regulator Sm2. The transmitting module 142c is different from the transmitting module 142b in that the output of the regulator 142a is not used.

### Third Example

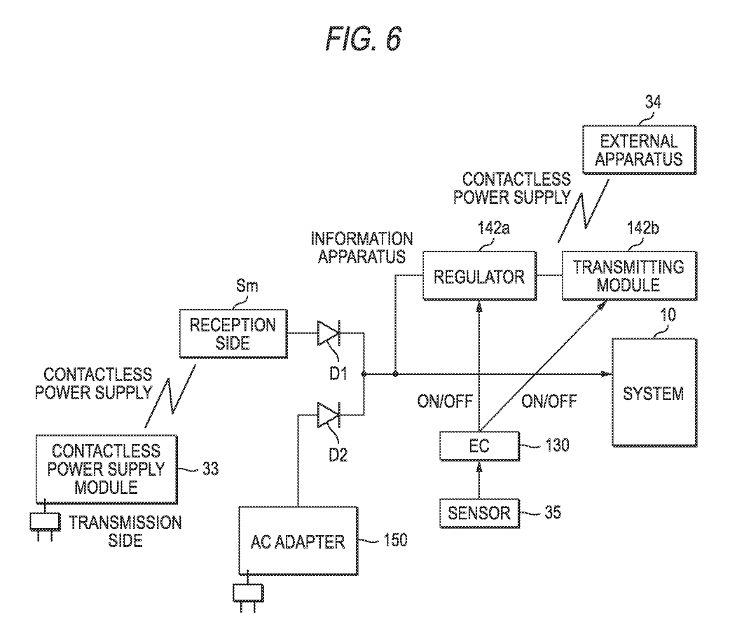

FIG. 6 is a functional block diagram showing a modification (ON/OFF of the transmitting module and the regulator (regulator 142a) of the preceding stage by sensor information) of the embodiment.

As shown in the modification block diagram of FIG. 6, when the transmitting module for a contactless power supply to an external apparatus is turned ON/OFF to/from the EC (EC/KBC 130) in conjunction with a sensor 35, the standby power is reduced. Specifically, assuming the example in which power is supplied when the LCD of the notebook PC is closed and the wireless mouse is placed on an upper portion thereof, the wireless mouse cannot be put on unless the LCD is closed. Therefore the power supply of the transmitting module for contactless power supply to an external apparatus and the regulator of the preceding stage is set so as to be turned ON only when the LCD is closed, in conjunction with an LCD opening/closing sensor disposed in the PC. The EC cooperates with the sensor 35 to constitute a controller which determines whether the cover is closed or not, and which, if it is determined to be not closed, suppresses the power consumption of the regulator of the preceding stage.

In the above-described embodiment, the transmitting module is disposed in the information apparatus having a contactless power supply reception function, and a contactless power supply is performed on the secondary battery in the external apparatus such as a wireless mouse. The contactless power supply transmitting module is disposed in the LCD cover of the notebook PC which can receive a contactless power supply, and, when the LCD of the notebook PC is closed, a wireless mouse is placed on the upper portion, thereby charging a secondary battery in the mouse. When electric power is supplied to the contactless power supply transmitting module without being passed through an output regulator in a contactless power supply receiving module, the power loss can be reduced by about 5 to 10%.

### Effects of Embodiment

In the first example, when the wireless mouse is placed on an upper portion of the notebook PC during a period when the LCD of the notebook PC is closed (during returning to the office, the holiday, and the like), the secondary battery in the mouse can be charged, and therefore the user's performance can be prevented from being lowered due to sudden battery exhaustion in the mouse.

In the second example, in addition to the effect of the first example, a reduction of the power conversion loss (about 5% to 10%) of the regulator is attained. In the case of a 10-W power supply (idling of the PC), for example, the loss is reduced by 500 mW, and, in the case of a 45-W power supply (high performance), the loss is reduced by 2.25 W.

In the third example, in addition to the effect of the first example, a reduction of the idle power consumption (for example, 10 mA*19 V=190 mW) of the regulator 142a is attained.

In the above-described embodiment, power supply devices related to a hub system of a contactless power supply function have been described. The invention is not limited to the embodiment, and may be further implemented by modifying in various manners without departing from the spirit of the invention.

Plural components disclosed in the above-described embodiment may be appropriately combined with each other, whereby various inventions may be formed. For example, some components may be omitted from the whole components indicated in the embodiment, and, components of different embodiments may be adequately combined with each other.

1. A power supply device comprising:
a body housing;
a cover which covers a body housing;
a receiving module which receives power from an external contactless power supply module; and
a transmitting module which is disposed in the cover, and which supplies power to an external apparatus.

2. The power supply device of claim 1,
wherein the transmitting module supplies power to the external apparatus through a contactless power supply.

3. The power supply device of claim 1,
wherein the transmitting module supplies power to the external apparatus upon closure of the cover.

4. The power supply device of claim 1,
wherein the external apparatus is a wireless mouse.

5. The power supply device of claim 1,
wherein the external apparatus has a rechargeable secondary battery.

6. The power supply device of claim 1, further comprising:
a regulator,
wherein the transmitting module supplies a power output of the receiving module to the external apparatus via the regulator.

7. The power supply device of claim 6, further comprising:
a controller which determines whether the cover is closed or not,
wherein, if it is determined to be not closed, the controller suppresses a power consumption of the regulator.
